(19) United States
(12) Patent Application Publication
(10) Pub. No.: US 2017/0339587 A1
(43) Pub. Date: Nov. 23, 2017

(54) WIRELESS COMMUNICATION METHODS AND APPARATUS

(71) Applicant: KABUSHIKI KAISHA TOSHIBA, Tokyo (JP)

(72) Inventors: Parag Gopal KULKARNI, Bristol (GB); Fengming CAO, Bristol (GB)

(73) Assignee: KABUSHIKI KAISHA TOSHIBA, Tokyo (JP)

(21) Appl. No.: 15/504,878

(22) PCT Filed: Feb. 9, 2015
(86) PCT No.: PCT/GB2015/050343

§ 371 Date: Feb. 17, 2017

(51) Int. Cl. H04W 24/08; H04L 12/24; H04W 72/08; H04W 88/08

(52) U.S. Cl. CPC H04W 24/08; H04W 72/085; H04L 41/0803; H04W 72/082; H04W 88/08

(57) ABSTRACT

In an embodiment a wireless communication method in an access point of a wireless network is disclosed. The access point comprises a wireless network interface configured to be switchable between a plurality of wireless communication channels. The method comprises monitoring each of a plurality of monitored channels from the plurality of channels, wherein monitoring a monitored channel comprises configuring the wireless network interface to monitor the monitored channel; identifying potentially interfering transmissions on the monitored channel and determining a count of potentially interfering transmissions on the monitored channel; calculating an interference metric for the monitored channel as a function of at least the count of potentially interfering transmissions on the monitored channel; and storing the interference metric for the monitored channel, comparing the stored interference metrics for the plurality of monitored channels and selecting as a communication channel the monitored channel having the lowest interference metric; and configuring the access point to communicate over the wireless network using the selected communication channel.

### FIELD

Embodiments described herein relate generally to wireless communication methods and apparatus and more specifically to channel selection by access points in a wireless network.

### BACKGROUND

Wireless Local Area Network (WLAN) technology has significantly matured over the last decade and while it continues to serve well, there are scenarios where it struggles to deliver acceptable performance for the most basic services. In particular, in scenarios with highly dense deployments, performance can deteriorate. One of the main causes of this deterioration is the overcrowding of devices in the unlicensed bands where WLANs typically operate. To add to the problem is an increase, not only in the number of users, but also the access points (APs) serving them, leading to overlapping regions of coverage in dense areas.

A problem that arises in such deployments is how an AP should choose its operating channel. Particularly in an unplanned setup, an AP may have little or no control over the multitude of APs operating in its radio neighbourhood, each one often making choices independently.

### BRIEF DESCRIPTION OF THE DRAWINGS

In the following, embodiments will be described with reference to the drawings in which:

FIG. 1 shows a wireless network according to an embodiment;

FIG. 2 shows an access point according to an embodiment;

FIG. 3 shows a wireless communication method according to an embodiment;

FIG. 4 shows a start-up procedure in an access point according to an embodiment;

FIG. 5 shows the data stored in the memory of an access point in an embodiment;

FIG. 6 shows a channel scanning method according to an embodiment;

FIG. 7 shows a method of switching channel in an embodiment;

FIGS. 8a and 8b show a network neighbourhood according to an embodiment; and

FIG. 9 shows an access point according to an embodiment.

### DETAILED DESCRIPTION

In an embodiment a method of wireless communication in an access point of a wireless network is disclosed. The access point comprises a wireless network interface configured to be switchable between a plurality of wireless communication channels. The method comprises monitoring each of a plurality of monitored channels from the plurality of channels, wherein monitoring a monitored channel comprises configuring the wireless network interface to monitor the monitored channel; identifying potentially interfering transmissions on the monitored channel and determining a count of potentially interfering transmissions on the monitored channel; calculating an interference metric for the monitored channel as a function of at least the count of potentially interfering transmissions on the monitored channel; and storing the interference metric for the monitored channel, comparing the stored interference metrics for the plurality of monitored channels and selecting as a communication channel the monitored channel having the lowest interference metric; and configuring the access point to communicate over the wireless network using the selected communication channel.

In an embodiment, monitoring a monitored channel further comprises determining a measure of the received signal strength for each identified potentially interfering transmission on the monitored channel and wherein the interference metric is a function of the count of potentially interfering transmissions on the monitored channel and a sum of the indications of the measure of the received signal strength for each potentially interfering transmission on the monitored channel.

In an embodiment, identifying potentially interfering transmissions on the monitored channel comprises receiving a transmission; determining a destination of the received transmission; and identifying the transmission as a potentially interfering transmission when the destination is not the access point.

In an embodiment, communicating over the wireless network using the selected communication channel comprises communicating using the wireless network interface.

In an embodiment, the access point comprises a first wireless network interface and a second wireless network interface, each being configured to be switchable between the plurality of wireless communication channels, wherein monitoring each of the plurality of monitored channels comprises switching the first wireless network interface to respective monitored channels from the plurality of monitored channels, and wherein communicating over the wireless network using the selected communication channel comprises switching the second wireless network interface to the selected communication channel.

In an embodiment, the interference metric is an average signal strength of the potentially interfering transmissions on the monitored channel.

In an embodiment, the interference metric is a moving average of signal strength of the potentially interfering transmissions on the monitored channel.

In an embodiment, the method further comprises transmitting an indication of the interference metric for the selected communication channel on the selected communication channel.

In an embodiment, a computer readable carrier medium carrying processor executable instructions which when executed on a processor cause the processor to carry out a wireless communication method according to the embodiments described above.

In an embodiment an access point for a wireless network is disclosed. The access point comprises a first wireless network interface configured to be switchable between a plurality of wireless communication channels; an identification module configured to identify potentially interfering transmissions on a monitored channel of the plurality of wireless communication channels and determine a count of potentially interfering transmissions on the monitored channel; a calculation module configured to calculate an interference metric for the monitored channel as a function of at least the count of potentially interfering transmissions on the monitored channel; a memory configured to store the interference metrics for each of the monitored channels; and a communication module configured to cause the access point to communicate over the wireless network using a communication channel selected by comparing the interference metrics stored in the memory.

In an embodiment, the communication module is configured to communicate on the selected communication channel using the first wireless network interface.

In an embodiment the access point further comprises a second wireless network interface, wherein the communication module is configured to communicate on the selected communication channel using the second wireless network interface.

In an embodiment, the identification module is further configured to determine a signal strength of the identified potentially interfering transmissions on the monitored channel and to determine a sum of the signal strengths of potentially interfering transmissions on the monitored channel, and wherein the calculation module is configured to calculate the interference metric for the monitored channel as a function of the count of potentially interfering transmissions and the sum of the signal strengths of the potentially interfering transmissions on the monitored channel.

In an embodiment, the identification module is configured to identify potentially interfering transmissions on the monitored channel by determining a destination of the received transmission; and identifying the transmission as a potentially interfering transmission when the destination is not the access point.

In an embodiment, the memory is configured to store a list of clients associated with the access point and the identification module is configured to identify transmissions originating from transmitters not on the list of clients associated with the access point as potentially interfering transmissions.

In an embodiment, the interference metric is an average signal strength of the potentially interfering transmissions on the monitored channel.

In an embodiment, the interference metric is a moving average of signal strength of the potentially interfering transmissions on the monitored channel.

In an embodiment, the communication module is further configured to transmit an indication of the interference metric for the selected communication channel on the selected communication channel.

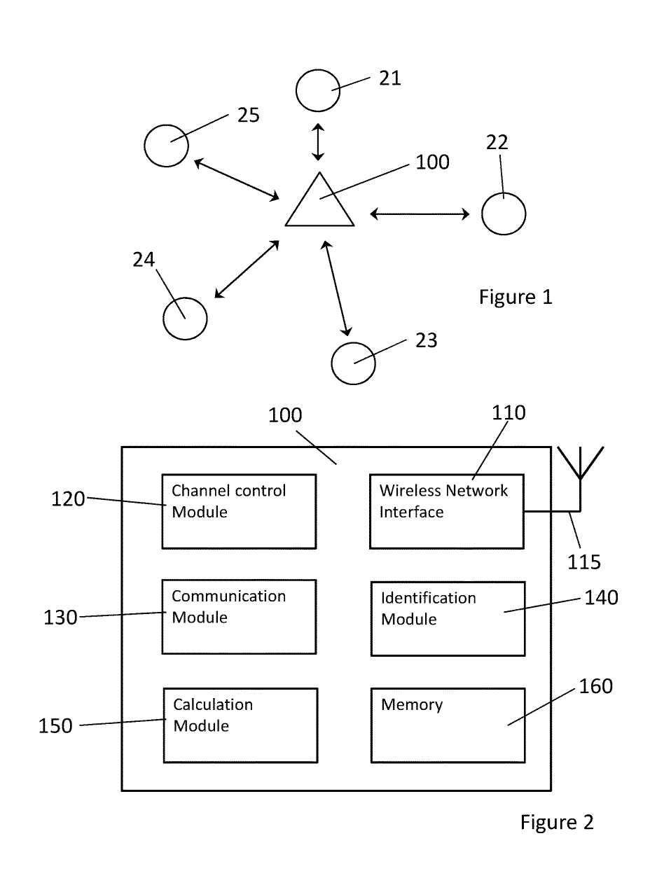

FIG. 1 shows a wireless network according to an embodiment. The wireless network comprises an access point (AP) 100, and five clients (STAs) 21, 22, 23, 24, 25. The clients communicate wirelessly with the access point 100 over a wireless channel.

FIG. 2 shows the AP 100 in further detail. The AP 100 comprises a wireless network interface 110, a channel control module 120, a communication module 130, an identification module 140, a calculation module 150 and a memory 160. The wireless network interface 110 is coupled to an antenna 115.

The wireless network interface 110 is operable to send and receive signals using the antenna 115 on one or more of a plurality of radio frequency channels defined in an radiofrequency spectrum. The channel control module 120 selects which of the radio frequency channels the wireless network interface 110 uses. The communication module 130 controls the wireless network interface 110 to send and receive signals according to a communication protocol, for example, to client STAs as described above in relation to FIG. 1.

The identification module 140 monitors the signals received by the wireless network interface 110 and determines whether detected signals are from clients associated with the AP 100 or are other communications related to another AP operating in the vicinity operating on the same channel as the AP 100. These signals may be either signals transmitted by neighbouring APs or signals transmitted by clients of the neighbouring APs. The calculation module 150 performs calculations on the data extracted by the identification module 140 from the signals related to other APs. The memory 160 stores data extracted from those signals.

The methods carried out by the modules of the AP 100 are described in more detail below.

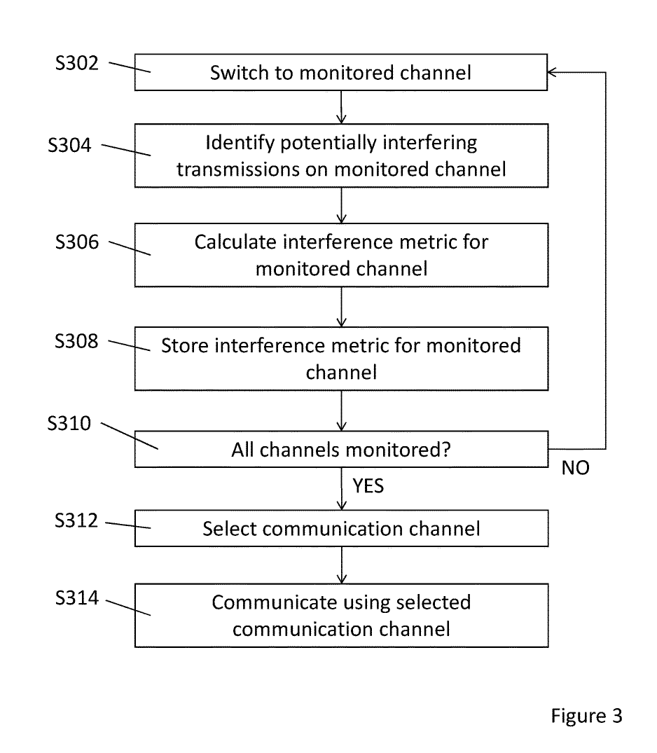

FIG. 3 shows a wireless communication method according to an embodiment. In step S302, the channel control module 120 causes the wireless network interface 110 to switch to a channel to be monitored, which is referred to in the following description as the monitored channel. In step S304, the identification module 140 identifies potentially interfering transmissions on the monitored channel. The identification module 140 identifies potentially interfering transmissions by comparing an identifier of the node from which the transmission originated with a list of clients associated with the AP 100. If the node does not exist on the list of clients associated with the AP 100 then the transmission is identified as a potentially interfering transmission. A count of potentially interfering transmissions on the monitored channel is stored in the memory 160. Each time the identification module 140 identifies a potentially interfering transmission, the count for the monitored channel is incremented.

In step S306, the calculation module 150 calculates an interference metric for the monitored channel. The interference metric is a function of the count of potentially interfering transmissions observed on the monitored channel. In addition to maintaining a count of potentially interfering transmissions, a sum of the observed signal strengths of the potentially interfering transmissions is also stored by the identification module 140. The interference metric is a function of both the sum of the signal strengths and the count of potentially interfering transmissions.

In step S308, the interference metric calculated for the monitored channel is stored in the memory 160. In step S310 a check is carried out as to whether all channels have been monitored. If there are still channels to be monitored, the method returns to step S302, with a new channel selected as the monitored channel. When all channels have been monitored, the method moves to step S312.

In step S312, a communication channel is selected. The communication channel is selected by comparing the interference metrics stored in the memory for each of the channels and selecting the channel having the lowest interference metric as the communication channel. In step S314, the AP 100 communicates with its clients using the selected communication channel.

An AP in accordance with the above described embodiment, operating on a channel ‘i’ may be in receipt of a variety of transmissions on that channel. Some of these transmissions could be from clients connected to this AP; some others could be management frame (e.g. beacons) transmissions from neighbouring APs operating in the vicinity on the same channel; and some could be transmissions from clients in the vicinity connected to neighbouring APs operating on the same channel. For the transmissions from clients associated with this AP, the frames will be decoded and passed to the higher layer.

For the transmissions from other devices such as other APs and clients connected to them, the signal strength recorded during frame reception will be stored and the rest of the frame will be discarded. It should be noted that, in some cases, only the header may be decodable and the frame may be un-decodable. There are two possible causes for this. Firstly, the client may be physically located far away from the AP, and signal attenuation may have an impact on reception quality. Secondly, in communications compliant with IEEE 802.11 standards and other technical specifications, the header of a frame is always sent at base rate even though the rest of the frame may be sent at higher rates, which may enable a header to be decodable through longer transmission distances than the rest of the frame.

In the context of this disclosure, only frames having at least decodable headers are considered. When an AP intercepts a transmission from a client, it can compare the node from which this transmission originated against the list of clients associated with itself. If a match is not found, this indicates interception of an interfering transmission. When intercepting such a transmission, the signal strength is recorded and the recorded value is added to a cumulative parameter and a counter is incremented. At the same time, an interference metric is computed. This could be the count of interfering transmissions experienced over a window or some function computed over the sum and count parameters. The reason for using a cumulative counter is that if many nodes in the neighbouring cells are quiet, the counter will likely have a low value whereas if the nodes in neighbouring cells are actively transmitting and within radio neighbourhood of the AP, the counter is likely to have a large value.

In the embodiment described above, the sum of the observed signal strengths is stored by the AP. In alternative embodiments, the average, maximum, median, or a moving average is stored.

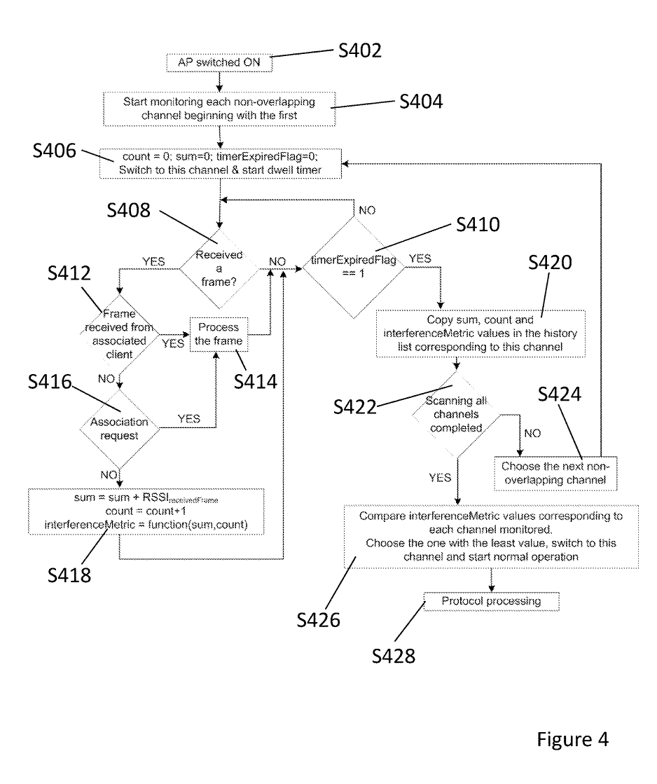

FIG. 4 shows a start-up procedure in an access point according to an embodiment. In step S402, the access point is switched on. After the AP powers on, it tunes to the first non-overlapping channel in step S404. The AP dwells on each channel for a fixed period of time until a dwell timer expires. In step S406, the values of count, sum and timerExpiredFlag are set to zero. Then the dwell timer is started for the monitored channel. The AP then gathers information on this channel and moves onto the next channel when the dwell timer expires. In step S408, the AP determines whether a frame has been received. If a frame has not been received, the method moves to step S410 in which the AP determines whether the dwell timer has expired. If the dwell timer has not expired, the method returns to step S408.

If in step S408, the AP determines that a frame has been received, the method moves to step S412. In step S412, the AP checks whether the received frame is associated with a client of the AP. If the received frame is associated with a client of the AP, the frame is processed in step S414 and the method returns to step S410. If the received frame is not associated with a client of the AP, the AP checks in step S416 whether the received frame is an association request. If the received frame is an association request, it is processed in step S414 and the method returns to step S410. If the received frame is not an association request, the method moves to step S418.

In step S418, an indication of the potential interference from the received frame is added to the sum value, and the counter is incremented. In this embodiment, the indication of potential interference from the received frame is the received signal strength indicator (RSSI) for the received frame. In step S418, the interference metric is also calculated from the sum and the count values. The interference metric is a function of the sum and count values. For example, the interference metric f(sum, count) may be the average signal strength of the interfering transmissions calculated as the sum divided by the count:

f(sum,count)=sum/count

The interference metric could be a moving average or the count value itself may be used as the interference metric.

Following step S418, the method moves to S410. As described above, in step S410, the AP determines whether the dwell timer has expired. If the dwell timer has expired, the method moves to step S420. In step S420 the values of sum, count and interference metric corresponding to the monitored channel are stored in the memory of the AP. Following step S420, the method moves to step S422.

In step S422 a check is carried out to determine whether all channels have been scanned. If all channels have not been scanned, the next un-scanned channel is selected as the monitored channel in step S424, and the method returns to step S406 for the new monitored channel. If all of the channels are determined to have been monitored in step S422, the method moves to step S426. In step S426, a channel is selected as the communication channel. The interference metric values for each of the monitored channels is compared, and the channel having the lowest interference metric is selected as the communication channel. The AP then switches to the channel selected as the communication channel and starts normal operation in this channel. The method then moves to step S428 in which protocol processing takes place. The protocol processing step S428 shown in FIG. 4 and the figures described below indicates that the AP communicating on a selected communication channel or is idle during communication on a selected communication channel.

As described above, the AP intercepts transmissions to capture the level of potential interference on each channel in its radio neighbourhood. The AP will maintain statistics for each non-overlapping channel over a certain window. The length of the window could be equal to the dwell time on the channel or longer. Upon expiration of the dwell time counter, the AP moves to the next channel and repeat the process. The process continues until the AP completes scanning all the non-overlapping channels. The objective of this exercise is to choose an operating channel where the AP can minimise the level of potential interference.

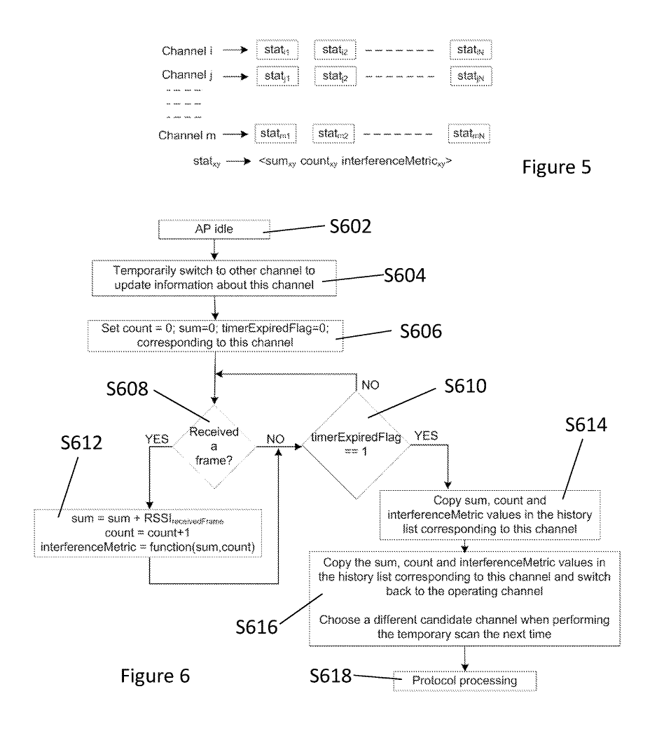

FIG. 5 shows the data stored in the memory of an AP in an embodiment. Each AP can maintain a historical list of the tuple <sum, count, interferenceMetric> as shown in FIG. 5. The length of this history is a tuneable parameter ‘N’. This list can be implemented e.g. using a sliding buffer such that whenever the list is full, the oldest value in the list is overwritten.

As shown in FIG. 5, the AP stores N sets of statistics (statᵢ₁, statᵢ₂, . . . stat_{iN}) for channel i, N sets of statistics (statⱼ₁, statⱼ₂, . . . stat_{jN}) for channel j, and corresponding sets of statistics for each channel up to channel m. In each case the statistics include the sum, count and interference metric values.

At the beginning of each new monitoring cycle, the parameters <sum, count, interferenceMetric> are all reset so that measurements indicate the recent state of the radio neighbourhood. Additionally, at the end of the monitoring cycle, any new statistics gathered are stored in the history list corresponding to the channel that was monitored. By storing historical information on ‘N’ recent monitoring cycles, the AP can identify up trends which could be factored in the channel selection/switching process.

In an embodiment, the AP may compute trends using time series prediction or a simple moving average. These trends are used to identify whether the potential interference is increasing, decreasing or remaining steady. The AP may compare the trends across different channels and the trends may be included in the channel selection process. In an embodiment, the AP may use a machine learning technique to identify cyclic trends such as whether particular channels have a high level of potential interference at particular times of day.

Assuming that an AP has a single radio card it will temporarily monitor other channels to keep potential interference information on these up to date. This monitoring may take place either periodically or when the AP is idle. The periodic monitoring process is shown in FIG. 6. In an embodiment the AP may carry out such monitoring in a reactive way. That is, the process shown in FIG. 6 is started when the AP experiences degraded performance.

FIG. 6 shows a channel scanning method according to an embodiment. In step S602, the AP determines that it is idle. In step S604, the AP temporary switches to another channel as a monitored channel to update information about the monitored channel.

As described above in relation to FIG. 4, the AP then dwells on the monitored channel for a fixed period of time until a dwell timer expires. In step S606, the values of count, sum and timerExpiredFlag are set to zero. Then the dwell timer is started for the monitored channel. The AP gathers information on this channel and moves onto the next channel when the dwell timer expires. In step S608, it is determined whether a frame has been received. If a frame has not been received, the method moves to step S610 in which it is determined whether the dwell timer has expired. If the dwell timer has not expired, the method returns to step S608.

If in step S608 it is determined that a frame has been received, the method moves to step S612. Since the AP is monitoring a channel on which it is not operating, any frames received are known not to be associated with the AP and can therefore be assumed to be potential interference.

In step S612, an indication of the potential interference from the received frame is added to the sum value, and the counter is incremented. As discussed above, the indication of potential interference from the received frame is the received signal strength indicator (RSSI) for the received frame. In step S418, the interference metric is also calculated from the sum and the count values. The interference metric is a function of the sum and count values.

Following step S612, the method moves to S610 in which it is determined whether the dwell timer has expired. If the dwell timer has expired, the method moves to step S614. In step S614 the values of sum, count and interference metric corresponding to the monitored channel are stored in the memory of the AP. Following step S614, the method moves to step S616.

In step S616, the values in a history list in the memory of the AP for the monitored channel are updated. The AP then switches back to the operating channel and a different candidate channel is selected as the monitored channel next time the AP performs a temporary scan. The method then moves to step S618 in which protocol processing takes place.

Another approach to gathering neighbourhood information on other channels is to utilise the information gathered by other neighbour APs operating in the vicinity on these channels. Each AP (for example AP1) is monitoring its neighbourhood on its operating channel (channel X). AP1 could then advertise this information (for example, sum, count, interference metric) via a beacon frame on the operating channel (channel X). Whenever another AP (AP2) operating another channel (channel Y), temporarily tunes to channel X to monitor the state of this channel, AP2 could simply capture the potential interference on channel X by listening to a beacon from AP1 provided both these APs are within range of each other. Whilst such an approach will render an approximate state of the neighbourhood, it can significantly speed up the scan time. Such an approach would therefore assist in estimation of potential interference on the candidate channels quickly.

The information advertised by the AP may be a latest value of the interference metric. Alternatively or additionally, the AP may advertise a summary value indicating trends or cyclic variations in the potential interference on the operating communication channel.

The AP may choose to switch its operating channel under different circumstances, e.g., when scan of neighbouring channel indicates availability of promising alternatives compared to the operating channel, the level of interference it is experiencing goes up (e.g. the retransmission rate goes above a certain threshold etc.) in comparison to what it was when the operating channel was chosen etc. Since each AP is dynamically monitoring and maintaining up to date information on different channels, at any given point in time, it can choose the one that promises to offer the best performance.

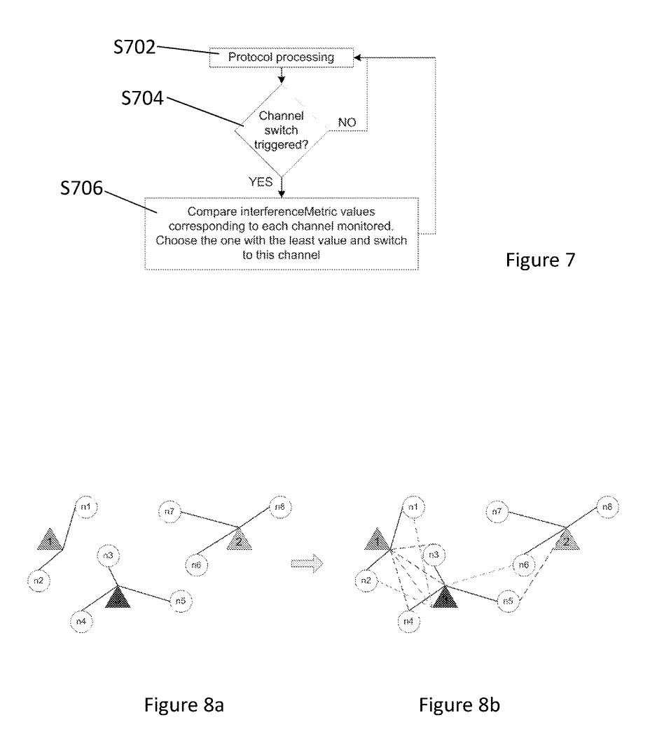

FIG. 7 shows a method of switching channel in an embodiment. In step S702, protocol processing takes place by the AP communicating on a selected communication channel. In step S704 it is determined whether a channel switch has been triggered. Examples of the channel switch are discussed in the paragraph above. If the channel switch has not been triggered, the method returns to step S702. If the channel switch has been triggered, the stored values of the interference metrics are compared and the channel having the lowest interference metric is selected as a new operating channel. Then the AP switches to the new operating channel and returns to step S702.

As discussed above, the interference metrics used in the comparison to select a new operating channel may be based on historical information on the monitored channels. The information in the history could be used to compute a summary value or determine other insights that could point to promising alternatives, for example by identifying cyclic variations or patterns in potential interference on the channels. A summary for each channel could be compared to yield the best alternative at the given time.

Another important issue to consider is avoiding synchronisation between neighbours, that is each neighbour, or pairs of neighbouring acting at the same time. To mitigate this problem, randomisation can be introduced. For example, instead of monitoring each channel sequentially, each AP could randomly select a channel such that it scans each of the available channels at least once per cycle. Moreover, randomisation can also be introduced during the channel switch process. In a scenario where two or more neighbours are on the same channel, it is desirable that they do not act at the same time. For example, it would be undesirable for two neighbouring APs to switch channel at the same time, and potentially both switch to the same or interfering channels. To avoid such simultaneous switching, APs could randomise their decision when faced with a channel switch option. In an embodiment the APs pick a random or pseudorandom number from a distribution and decide a course of action if this random number is less than a threshold.

FIG. 8a shows a network neighbourhood according to an embodiment. As shown in FIG. 8a, a first AP 1 has two clients n1 and n2. A second AP 2 has three clients n6, n7 and n8. A third AP3 has three clients n3, n4 and n5.

FIG. 8b shows communications intercepted by APs in the network neighbourhood shown in FIG. 8a during channel scans. As shown in FIG. 8b, the first AP 1 intercepts frames transmitted by two of the clients n3 and n4 associated with the third AP 3. Additionally, the first AP 1 also intercepts frames transmitted by the third AP 3. Thus during a channel scan according to an embodiment, the first AP 1 would determine a count of the transmissions transmitted by the two clients n3 and n4 and the third AP 3, and also an indication of the strengths of the transmissions. Thus the first AP 1 would have an indication of the potential interference on the channel on which third AP 3 is operating due to the communications between the third AP 3 and its clients.

As shown in FIG. 8b, the second AP 2 intercepts communication by one of the clients n6 associated with the third AP 3. Thus, during a channel scan, the second AP 2 would determine a count and the sum of strength indication of the transmissions by the client n5 of the third AP 3.

Further as shown in FIG. 8b, the third AP3 would intercept transmissions by the first AP 1, the two clients n1 and n2 associated with the first AP 1 and also by a client n6 of the second AP 2. Thus if the first AP 1 and the second AP 2 were operating on the same channel, it is likely that the third AP 3 would determine a relatively large level of potential interference on that channel during a scan. If this was the case, the third AP 3 would then select an alternative channel either during start-up or following a channel switch trigger.

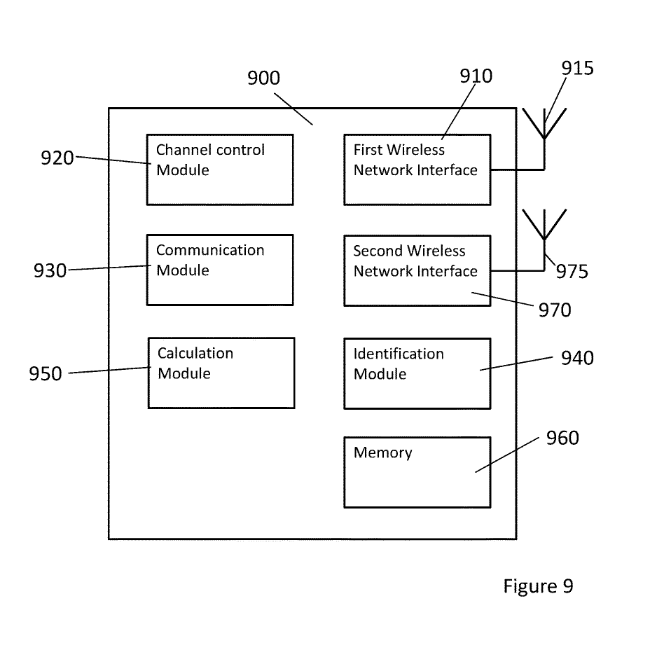

In the embodiments described above, the access points comprise a single radio card, or wireless network interface. In an alternative embodiment the access point comprises two radio cards. FIG. 9 illustrates such an embodiment.

FIG. 9 shows an access point according to an embodiment. The access point 900 comprises a first wireless network interface 910, a second wireless network interface 970, a channel control module 920, a communication module 930, an identification module 940, a calculation module 950 and a memory 960. The first wireless network interface 910 is coupled to a first antenna 915 and the second wireless network interface 970 is coupled to a second antenna 975.

Both the first wireless network interface 910 and the second wireless network interface 970 are operable to send and receive signals using the first antenna 915 and the second antenna 975 respectively. Each of the first wireless network interface 910 and the second wireless network interface 970 operate on one channel selected from a plurality of radio frequency channels. The channel control module 920 selects which of the radio frequency channels the first wireless network interface 910 uses and which channel the second wireless network interface 970 uses.

In this embodiment, the first wireless network interface 910 is used for communication with clients associated with the access point 900 using a communication channel selected from the plurality of possible channels. The second wireless network interface 970 may be simultaneously used to scan other channels. The communication module 930 controls the first wireless network interface 910 to send and receive signals according to a communication protocol.

The second wireless network interface 970 may be controlled by the channel control module 920 to operate on a different channel from the first wireless communication module 910. Thus the second wireless network interface 970 may be used to carry out a scan as shown in FIG. 6 from steps S604 to S616. That is the scan may be carried out even when the AP 900 is not idle.

In an embodiment, the identification module 940 monitors the signals received by the first wireless network interface 910 and determines whether detected signals are from clients associated with the AP 900 or are other communications related to another AP operating in the vicinity. The calculation module 950 performs calculations on the data extracted by the identification module 940 from the signals related to other APs. The memory 960 stores data extracted from those signals. This allows the AP 900 to gather information about interference on the channel on which it is communicating in addition to monitored channels.

Embodiments have the benefit that the AP can take into account of the potential for interfering transmissions on each channel and can choose the one where this potential is the least. Moreover, dynamic monitoring and maintaining historical information can provide additional useful information that could potentially improve the channel selection/switching decisions. Additionally, embodiments can be implemented without the need for any modifications other devices operating in the same network neighbourhood. Using the methods described above, an AP can build a picture of neighbouring channels and choose a channel which offers the potential for least interference.

In embodiments, since each access point makes decisions independently in a distributed manner, there is no need for a centralised controller. Moreover, in scenarios where multiple APs belonging to different administrative entities share the radio neighbourhood, a centralised approach may not be achievable. Embodiments allow APs to operate in an uncertain radio environment, in particular in which facilities may not exist for an AP to initiate change in another AP, each AP can at least try to choose the path of least resistance where possible.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the management unit described above in relation to the embodiments. Besides these two positions, a multi-function hardware device, such as a DSP, a FPGA or the like, could be configured by configuration instructions.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A wireless communication method in an access point of a wireless network, the access point comprising a wireless network interface configured to be switchable between a plurality of wireless communication channels, the method comprising
monitoring each of a plurality of monitored channels from the plurality of channels, wherein monitoring a monitored channel comprises
configuring the wireless network interface to monitor the monitored channel;
identifying potentially interfering transmissions on the monitored channel and determining a count of potentially interfering transmissions on the monitored channel;
calculating an interference metric for the monitored channel as a function of at least the count of potentially interfering transmissions on the monitored channel; and
storing the interference metric for the monitored channel,
comparing the stored interference metrics for the plurality of monitored channels and selecting as a communication channel the monitored channel having the lowest interference metric; and
configuring the access point to communicate over the wireless network using the selected communication channel.

2. A method according to claim 1, wherein monitoring a monitored channel further comprises determining a measure of the received signal strength for each identified potentially interfering transmission on the monitored channel and wherein the interference metric is a function of the count of potentially interfering transmissions on the monitored channel and a sum of the indications of the measure of the received signal strength for each potentially interfering transmission on the monitored channel.

3. A method according to claim 1, wherein identifying potentially interfering transmissions on the monitored channel comprises receiving a transmission; determining a destination of the received transmission; and identifying the transmission as a potentially interfering transmission when the destination is not the access point.

4. A method according to claim 1, wherein communicating over the wireless network using the selected communication channel comprises communicating using the wireless network interface.

5. A method according to claim 1, wherein the access point comprises a first wireless network interface and a second wireless network interface, each being configured to be switchable between the plurality of wireless communication channels, wherein monitoring each of the plurality of monitored channels comprises switching the first wireless network interface to respective monitored channels from the plurality of monitored channels, and wherein communicating over the wireless network using the selected communication channel comprises switching the second wireless network interface to the selected communication channel.

6. A method according to claim 1, wherein the interference metric is an average signal strength of the potentially interfering transmissions on the monitored channel.

7. A method according to claim 1, wherein the interference metric is a moving average of signal strength of the potentially interfering transmissions on the monitored channel.

8. A method according to claim 1, further comprising transmitting an indication of the interference metric for the selected communication channel on the selected communication channel.

9. A computer readable carrier medium carrying processor executable instructions which when executed on a processor cause the processor to carry out a method according to claim 1.

10. An access point for a wireless network, the access point comprising
a first wireless network interface configured to be switchable between a plurality of wireless communication channels;
an identification module configured to identify potentially interfering transmissions on a monitored channel of the plurality of wireless communication channels and determine a count of potentially interfering transmissions on the monitored channel;
a calculation module configured to calculate an interference metric for the monitored channel as a function of at least the count of potentially interfering transmissions on the monitored channel;
a memory configured to store the interference metrics for each of the monitored channels; and
a communication module configured to cause the access point to communicate over the wireless network using a communication channel selected by comparing the interference metrics stored in the memory.

11. An access point according to claim 10, wherein the communication module is configured to communicate on the selected communication channel using the first wireless network interface.

12. An access point according to claim 10, further comprising a second wireless network interface, wherein the communication module is configured to communicate on the selected communication channel using the second wireless network interface.

13. An access point according to claim 10, wherein the identification module is further configured to determine a signal strength of the identified potentially interfering transmissions on the monitored channel and to determine a sum of the signal strengths of potentially interfering transmissions on the monitored channel, and wherein the calculation module is configured to calculate the interference metric for the monitored channel as a function of the count of potentially interfering transmissions and the sum of the signal strengths of the potentially interfering transmissions on the monitored channel.

14. An access point according to claim 10, wherein the identification module is configured to identify potentially interfering transmissions on the monitored channel by determining a destination of the received transmission; and identifying the transmission as a potentially interfering transmission when the destination is not the access point.

15. An access point according to claim 10, wherein the memory is configured to store a list of clients associated with the access point and the identification module is configured to identify transmissions originating from transmitters not on the list of clients associated with the access point as potentially interfering transmissions.

16. An access point according to claim 10, wherein the interference metric is an average signal strength of the potentially interfering transmissions on the monitored channel.

17. An access point according to claim 10, wherein the interference metric is a moving average of signal strength of the potentially interfering transmissions on the monitored channel.

18. An access point according to claim 10, wherein the communication module is further configured to transmit an indication of the interference metric for the selected communication channel on the selected communication channel.
